(19) United States
(12) Patent Application Publication
(10) Pub. No.: US 2010/0092904 A1
(43) Pub. Date: Apr. 15, 2010

(54) DEVICE FOR POSITIONING AT LEAST ONE ORTHODONTIC ELEMENT

(75) Inventors: Alessio Esposti, Watermaal Bosvoorde (BE); Bert Van Roie, Kessel-Lo (BE); Carl Van Lierde, Meerbeke (BE)

Correspondence Address: CLARK & ELBING LLP, 101 FEDERAL STREET, BOSTON, MA, 02110, US

(73) Assignee: Materialise Dental N.V., Leuven (BE)

(21) Appl. No.: 12/526,925

(22) PCT Filed: Dec. 21, 2007
(86) PCT No.: PCT/EP07/11491

§ 371 Date: Aug. 12, 2009

(30) Foreign Application Priority Data
Feb. 19, 2007 (GB) 0703141.2

(51) Int. Cl. A61C 7/02; G06F 17/50

(52) U.S. Cl. 433/3; 700/98

(57) ABSTRACT

A device (10) is provided for positioning at least one orthodontic element (300) on a dentition (100) by means of an orthodontic element holder (500) for holding at least one orthodontic element (300). The device (10) comprises a positioning template (101) for fitting on at least a part of the dentition (100). The positioning template (101) has at least one open area (200) for allowing an orthodontic element (300) to contact the dentition (100). The positioning template (101) has an inner surface (102) for contacting the at least a part of the dentition (100). The positioning template (101) is further provided with at least one guide (400) coupled to and extending from the positioning template (101) in a direction away from the dentition (100) when the inner surface (102) is in contact with the dentition (100). The at least one guide (400) is suitable for cooperating with an orthodontic element holder (500) for guiding the orthodontic element (300) held by the orthodontic element holder (500) to the at least one open area (200).

### TECHNICAL FIELD OF THE INVENTION

This invention relates to the field of orthodontics and more specifically to bonding techniques for placing an orthodontic element, such as a bracket, on a dentition comprising teeth or on a physical model of a dentition comprising teeth, which techniques are based on a computer planning. The present invention further relates to a method to provide a device for positioning at least one orthodontic element on the dentition of a patient or on a physical model of a dentition, and to a device for positioning at least one orthodontic element on the dentition of a patient or on a physical model of a dentition.

### BACKGROUND OF THE INVENTION

The aim of orthodontic treatment is to correctly position and orient a patient's teeth. This can be done by using removable or fixed appliances which are in contact with the teeth and exert a force on them. The term fixed appliances usually refers to the well-known brackets or bands which are glued or cemented onto the teeth. They contain a slot in which an archwire is inserted to exert the necessary force to move the teeth.

In the straight-wire concept the brackets are designed so that the ideal tooth orientation and position is achieved by aligning all brackets with their slots on a smoothly curved archwire. This confers great importance to the initial placement of the brackets, both with respect to position and orientation. Guidelines based on the size and anatomy of the tooth crowns help the orthodontist in positioning the brackets as accurately as possible. However the standard direct bonding method has a limited accuracy since it involves taking the bracket with tweezers and pressing it to the tooth surface at the location which is the best according to the orthodontist's judgment.

One way of improving the accuracy of the placement of brackets is via the indirect bonding technique. In the traditional embodiment of this technique, brackets are first positioned on a plaster model duplicate of the patient's teeth. This has the advantage that the orthodontist can first perform measurements and draw landmarks on the model to indicate the ideal bracket positions, before actually gluing the brackets to the model. In a second step a transfer device is created over the model containing the brackets.

One example of such a transfer device involves using a two-tray technique: a first flexible tray is formed over the brackets and the plaster model, tightly fitting the brackets and precisely matching the shape of the teeth. Over this flexible tray a harder tray is formed. Both trays are removed from the model while the brackets remain in the flexible tray. After cleaning the bracket bases, bonding adhesive is applied to the bases and the flexible tray is positioned on the patient's teeth. The hard tray is then added to provide enough pressure while the adhesive is cured. After removing the trays, the brackets remain on the teeth in the same location and with the same orientation as they were positioned originally on the plaster model. A problem with this method is that it is difficult to regulate the amount of pressure which is exerted on each bracket. It is also necessary to create a physical model of the patient's dentition to be able to create the trays.

A second example of an indirect bonding device uses individual jigs per tooth, where each jig is formed individually over the bracket that is glued to the plaster model and over the tooth. In this way, the jig both holds the bracket and is shaped according to the shape of the tooth, so that the unique location and orientation of the bracket can also be transferred. The limited width of the jigs, however, limits the possibility of uniquely placing the jig in the patient's mouth. Jigs can be interchanged between similar teeth in a different quadrant and even when positioned on the correct tooth, they may still allow some translation of the bracket because of limited structure in the tooth surface.

More recently, 3D computer planning has given the orthodontist new possibilities in planning treatment and accomplishing this planning. The process starts by obtaining a digital representation of the patient's dentition, which is a digital equivalent of the traditional plaster models. The software then assists the user to position virtual brackets on these digital teeth, providing tools to find the ideal bracket locations.

Several systems are known for transferring the position and orientation of brackets from a computer planning to the patient's mouth.

U.S. Pat. No. 6,334,772, U.S. Pat. No. 6,976,840, and U.S. Pat. No. 7,147,464 describe a visual guiding system which involves a bracket positioning tool with a camera mounted on it. The camera provides an image of the current location of the bracket which is compared continuously with the planned location on a computer screen. Visual markers on the image indicate the difference between the planned location and the actual location of the bracket. When the bracket is close enough to the planned position, the operator bonds the bracket to the tooth. The same system can also be used for bonding brackets to a physical model of the patient's dentition and preparing a traditional indirect bonding device.

This technique requires a substantial training of the orthodontist, since he has to learn how to work with the system. Moreover there is a substantial risk of malpositioning the brackets since the operator can easily position the brackets differently than planned. Creating an indirect bonding tray via this method requires a substantial amount of manual work: a plaster model has to be created, each bracket has to be bonded to the model individually and creating the trays also requires human interaction.

According to U.S. Pat. No. 6,905,337 a tooth template can be created for bracket positioning. The template is made by printing the outline of the teeth and the bracket positions on a flexible sheet of material and cutting the sheet following the outline of the teeth and the bracket positions. The sheet is adhered to the patient's teeth or a model of the teeth, indicating the bracket positions by means of holes cut out of the template. The user then directly bonds the brackets to the surface of the teeth.

Drawback of this procedure is that the positioning of the sheet is not unique, since it is only the judgment of the user that decides whether it is positioned correctly. Moreover, there is no control whether the bracket is positioned precisely as indicated by the sheet.

In U.S. Pat. No. 6,918,761 a method is disclosed for positioning orthodontic brackets on a physical model of the patient's teeth using a robot which transfers the bracket positions from a computer planning to the model. An indirect bonding device can then be created in the traditional way. This approach requires a sophisticated and expensive computer guided robot for positioning the brackets on the model. Moreover, it still requires the production of a physical model of the patient's dentition and the manual fabrication of a transfer device.

U.S. Pat. No. 6,554,613 discloses the fabrication of a transfer jig for use on single teeth. To produce the jigs, the computer planning displaying of the patient's dentition and the brackets at their planned locations, is printed directly in 3D via a layer by layer approach. This yields a physical model of the brackets on the teeth, created in one piece and in the same material. The jigs are then formed over each individual tooth with its corresponding bracket on the model.

This is obviously an expensive procedure, since it requires the creation of both a model of placement and the actual jig. Due to their limited size, jigs can often be interchanged between two similar teeth and their positioning is often not unique.

According to U.S. Pat. No. 7,094,053 a jig can be constructed which holds the bracket with a pin engaged in a hole in the bracket. This implies that this system can only be used with specifically designed brackets having the appropriate hole.

A dental template covering multiple teeth is described in U.S. Pat. No. 7,056,115. The template is a piece of plastic material of uniform thickness which is created to match the shape of the teeth of the patient. Holes are left out where the brackets have to be positioned. The user positions the template on the patient's teeth and glues the brackets to the locations where there are holes, using regular tweezers. The design of the template involves creating a scaled version of the tooth model and superimposing this over the original tooth model.

A disadvantage of this system is the very limited contact which is possible between the template and the bracket base because of the small dimensions of the latter. This implicates that the bracket is not guided to its planned position, but the user still has full control in positioning the bracket in the hole indicated by the template. Since there always has to be some clearance between the template and the contour of the bracket base to allow for easy removal of the template, deviations from the planned position of the bracket are still possible.

Literature (“Rapid prototyping: A new method of preparing trays for indirect bonding”, Fabio Ciuffolo, Ettore Epifania, Gionni Duranti, Valentina De Luca, Daniele Raviglia, Silvia Rezza, and Felice Festae, American Journal of Orthodontics and Dentofacial Orthopedics 129, pp 75-77, 2006) further describes software which allows the orthodontist to design a transfer device based on the positions of virtual brackets on a virtual representation of a patient's dentition. The transfer device consists of rigid jigs for individual teeth or a few neighbouring teeth together, which surround the bracket entirely except for the side which is to be bonded to the tooth. The device is created via a rapid prototyping technique. Individual jigs created via this approach still have the drawback that their position is not unique on all teeth. Jigs covering a few teeth don't allow a controlled pressure per bracket anymore. Moreover, the rigidity of the jigs makes it impossible to bond a large portion of the dentition at once, since the bonded brackets would obstruct the jig or even prevent its removal.

### SUMMARY OF THE INVENTION

It is an object of embodiments of the present invention to provide good apparatus or methods for positioning at least one orthodontic element on the dentition of a patient or on a physical model of a dentition.

The above objective is accomplished by a method and device according to the present invention.

It is an advantage of embodiments of the present invention that at least one of the limitations of the techniques mentioned above is overcome. The present invention, in embodiments thereof, provides a device for transferring a computer planning of placement of orthodontic elements (such as brackets) to a physical part via guided direct bonding. The physical part can be the dentition of a patient or a physical model of a dentition. Guidance denotes limiting the movement of the orthodontic element, e.g. bracket, during placement with one or more degrees of freedom. The present invention, in embodiments thereof, further provides a device for positioning at least one orthodontic element on the dentition of a patient or on a physical model of a dentition, which device has a reduced risk in misaligning the orthodontic element on the dentition of the model of the dentition. The present invention, in embodiments thereof, further provides a method for producing a device for positioning at least one orthodontic element on the dentition of a patient or on a physical model of a dentition, which device is based on computer planning of orthodontic elements to a dentition of a patient.

According to a first aspect of the present invention, a device is provided for positioning at least one orthodontic element on a dentition by means of an orthodontic element holder for holding the at least one orthodontic element. With dentition in the light of the present invention is meant the dentition of a patient, or a physical model of a dentition. The device comprises a positioning template for fitting on at least a part of the dentition. The positioning template has at least one open area for allowing an orthodontic element to contact the dentition. The positioning template has an inner surface for contacting the at least a part of the dentition. The positioning template is further provided with at least one guide coupled to and extending from the positioning template in a direction away from the dentition when the inner surface is in contact with the dentition. The at least one guide is suitable for cooperating with an orthodontic element holder for guiding the orthodontic element held by the orthodontic element holder to the at least one open area.

The positioning template may have an outer surface opposite to the inner surface. The guide may be coupled to the outer surface of the positioning template and may extend from the outer surface in a direction away from the inner surface, i.e. away from the dentition of a patient or a physical model of a dentition when in contact with the inner surface. The inner surface of the positioning template is to be understood opposite to the outer surface of the positioning template.

The at least one “guide” thus is suitable for directing the motion of an orthodontic element holder to the at least one open area in the positioning template.

The device may further comprise the orthodontic element holder, which has a volume or shape, suitable to cooperate with the guide, optionally for cooperating with the guide according to one relative position.

The positioning template thus is adapted to receive an orthodontic element holder via the guide which extends from the template, more particularly from its outer surface.

The positioning template may fit uniquely on at least a part of the dentition, being the primary or secondary dentition of a patient, or a physical model of the primary or secondary dentition of a patient.

The positioning template may fit on at least a part of the upper or lower dentition of a patient or a physical model of an upper or lower dentition.

The positioning template may fit to the complete dentition of a patient or a physical model of a dentition.

The orthodontic element may be a bracket.

The device according to embodiments of the present invention allows the orthodontic element holder to move and thereby bring the orthodontic element to the exact place on the dentition or the dentition model. As the guide extends from the positioning template outwardly, i.e. in a direction opposite to the dentition, the orthodontic element holder may be guided along a path, which extends from the positioning template's inner surface. This corresponds to the direction along which the orthodontist usually will bring the orthodontic element to the position on the dentition or model of the dentition. The guide being extended with respect to the positioning template provides optimal guidance. With embodiments according to the present invention, a more accurate guiding may be obtained. This is in particular very helpful in case the orthodontic element is to be positioned on molars, which are more difficult to reach with orthodontic instruments, since the cheek may obstruct approximation of the side surfaces of the molars. Malpositioning of the orthodontic elements, such as brackets, is minimised, if not avoided. The device is also advantageous when used for placing orthodontic elements at the lingual side of the tooth or teeth. Orthodontic elements, such as brackets, are glued onto the non-visible lingual faces of the teeth. This is difficult because of a lack of visibility. The method and device according to embodiments of the invention allow orthodontic elements to be placed without the necessity to visually see the location where the orthodontic element is brought in contact with the lingual side of the tooth.

Optionally, the guide extends from the positioning template, e.g. the positioning template's outer surface, over a height ranging from 2 mm to 20 mm.

The device is adapted to allow cooperation of two elements: a positioning template and an orthodontic element holder, e.g. a bracket holder.

The positioning template can be a rigid tray which fits uniquely on at least part of the dentition of the patient. It has a mating region on the teeth which can be designed based on surface information of the dentition. The template may be provided with one or more guides, such as tubular guides having a guiding shafts, which limit the movement of the orthodontic element holder and guides it to the correct position and orientation for attaching, e.g. gluing, the orthodontic elements, e.g. brackets.

The positioning template may comprise one or more apertures to allow the orthodontic elements, e.g. brackets, to slide out when the positioning template is lifted after bonding of the orthodontic elements onto the dentition. The positioning template can be produced via rapid prototyping techniques, such as 3D printing, or via CAD/CAM (e.g. high speed milling) techniques. The guide or guides may be provided to the positioning template via rapid prototyping techniques, such as 3D printing, or via CAD/CAM (e.g. high speed milling) techniques, i.e. for example during the same production step.

The orthodontic element holder, e.g. a bracket holder, may have means for holding an orthodontic element, e.g. a bracket, such as via a clamping part or holds the orthodontic element, e.g. the bracket, via friction. It may engage the orthodontic element, e.g. the bracket, for instance in a slot or on its side surfaces. It can be a customized part per orthodontic element type, e.g. per bracket type, a customized part per patient and per tooth, or it can be a standard tool. Necessary movements or a force to bond the orthodontic element, such as the bracket, can adequately be exerted on the orthodontic element, such as the bracket, via the orthodontic element holder, e.g. a bracket holder. The shape of the orthodontic element holder, e.g. the bracket holder, may be such that it can be guided by at least one of the guides, optionally a tubular guide having a guiding shaft, in the positioning template. The orthodontic element holder, e.g. the bracket holder, may be made out of polymer or metal.

The positioning template, used in combination with an orthodontic element holder, such as a bracket holder, provides a means for uniquely positioning one or more orthodontic elements, e.g. brackets, on the teeth via the guide or guides. The orientation and location of the orthodontic element, e.g. the bracket, may be fully included in the positioning template, where the orthodontic element holder, e.g. bracket holder, is for providing a known position of the orthodontic element, e.g. bracket, with respect to the guide. As an example, in case the guide is a tubular guide comprising a guiding shaft, the orthodontic element may be positioned in a known position relative to the guide, e.g. in the middle of the shaft.

Alternatively, the exact orientation and location of the orthodontic element, e.g. bracket, may be included in the orthodontic element holder, e.g. bracket holder, when the guides are positioned via a standard way in the positioning template (e.g. in the middle of and perpendicular to the tooth surface). According to another alternative, unique positioning may be accomplished by a combination of both approaches.

According to some embodiments of the present invention, the at least one guide may be a tubular guide having an axial direction, the axial direction extending in a direction away from the inner surface. The tubular guide defines a shaft in axial direction, the shaft being suitable for cooperating with the orthodontic element holder.

The shaft is to be understood as an opening of substantially limited cross section being suitable for cooperating with the orthodontic element holder. Optionally the shaft may have a substantially uniform cross section along its axial direction, the different cross sections being made by means of planes perpendicular to the axial direction.

According to some embodiments of the present invention, the shaft may have a wall with an inner surface being suitable for contacting the outer surface of the orthodontic element holder.

According to some embodiments of the present invention, the wall of the shaft may be open, e.g. provided with at least one aperture, along at least part of the axis.

A shaft may have a wall with or without apertures and may engage the entire surface of the orthodontic element holder, e.g. bracket holder, or only part of it.

According to some embodiments of the present invention, the wall of the shaft may be provided with an aperture at the coupling of the tubular guide to the positioning template, e.g. at the outer surface of the positioning template.

The wall not being provided with an aperture at a given position along the axial direction means that along that part of the length of the tubular guide in axial direction, the cross section of the surface by a plane perpendicular to the axial direction defines a section being a closed curve. The wall being provided with an aperture at a given position along the axial direction means that along that part of the length of the tubular guide in axial direction, the cross section of the surface by a plane perpendicular to the axial direction defines a section being an open curve. The shaft may be provided with an aperture along a first part of its length and may not be provided with an aperture along the other part of its length.

According to some embodiments of the present invention, the tubular guide may have an aperture for allowing removal of the device from the dentition of a patient or a physical model of a dentition after positioning the orthodontic element.

The aperture may have at least one side delimited by the open area of the positioning template.

According to some embodiments of the present invention, the device further may comprise an orthodontic element holder, suitable to cooperate with the at least one guide.

According to some embodiments of the present invention, the orthodontic element holder and the guide may have an aligning means for aligning the orthodontic element holder and the guide in a unique relative position during guiding of the orthodontic element holder by the guide. To “align” is to be understood as to be in or come into precise adjustment or correct relative position.

Such aligning means may be a recession or a slot in axial direction in the inner surface of the tubular guide, the guide having a raised part at its outer surface, for engaging, e.g. slidingly engaging, in this slot in a unique position.

Alternatively the orthodontic element holder may fit in and move, e.g. slide, within the inner surface of the guide in axial direction, by providing an outer surface of the orthodontic element holder, which outer surface matches or engages with the inner surface in only one position of the orthodontic element holder relative to the axis of the tubular guide.

As an example, the inner surface of the tubular guide may be substantially identical to the outer surface of the orthodontic element holder with respect to shape, the radial cross sections of the surfaces for example having a triangular shape of which at least two sides have a different length, or having a quadrangular shape having at least three sides having a different length, e.g. like a trapezoid shape.

According to some embodiments of the present invention, the open area of the positioning template may extend up to the soft tissue edge of the positioning template for allowing removal of the device from the dentition of a patient or a physical model of a dentition after positioning the orthodontic element. The open area hence may have a part having a slit-like shape, which extends from the position where the orthodontic element is to be placed up to the soft tissue edge of the template.

The “soft tissue edge” of the positioning template is the edge of the positioning template to be oriented to the soft tissue at the side of the tooth or teeth to which the orthodontic element is to be placed. The soft tissue edge may be oriented to e.g. the buccal side or to the lingual side of the soft tissue.

A device according to the first aspect of the present invention may be obtained by using a method according to the second aspect of the present invention.

According to a second aspect of the present invention, a method for manufacturing a device for positioning at least one orthodontic element on the dentition of a patient or on a physical model of a dentition is provided. The method comprises the steps of:
Obtaining a digital model of a patient's dentition;
Digitally positioning, i.e. defining the position of, at least one digitally modelled orthodontic element in the digital patients dentition model;
Determining a digitally modelled orthodontic element holder for holding at least one orthodontic element;
Determining, based on said at least one digitally positioned orthodontic element, a digital model of a positioning template for fitting on at least a part of the dentition of a patient or a physical model of a dentition, the positioning template having at least one open area for allowing an orthodontic element to contact the dentition according to the digitally defined position, the positioning template having an inner surface for contacting the at least a part of the dentition, the positioning template further being provided with at least one guide coupled to and extending from the positioning template in a direction away from the dentition when the inner surface is in contact with the dentition, the at least one guide being suitable for cooperating with an orthodontic element holder for guiding the orthodontic element held by the orthodontic element holder to the at least one open area;
providing the positioning template of the device for positioning the at least one orthodontic element on the dentition.

Optionally the digitally modelled orthodontic element holder for holding at least one orthodontic element may be a simplified representation of an orthodontic element holder suitable for holding at least one orthodontic element. The representation may comprise the essential features necessary to allow cooperation of the holder with the guide.

Optionally, the digitally modelled orthodontic element holder for holding at least one orthodontic element may be positioned, i.e. defining the position of digitally modelled orthodontic element holder, with respect to the digital model of a patient's dentition. This positioning may be e.g. automatically positioning.

Providing the device means that the device is physically produced, i.e. realized and made suitable for use.

The digital model of a patient's dentition may be obtained by any suitable method to provide a digital representation of the patients dentition, either directly by e.g. intraoral scanning of the teeth, via a volumetric scan (e.g. CT, CBCT and alike) or via scanning of a physical model of the patients dentition or scanning of a negative (impression) of the teeth.

According to some embodiments of the present invention, an orthodontic element holder may be selected from a group of digitally modelled orthodontic element holders, the guide being defined and fit in the digitally modelled positioning template in function of the selected digitally modelled orthodontic element holder and the position of the at least one digitally modelled orthodontic element in the digital patients dentition model.

According to some embodiments of the present invention, an orthodontic element holder may be selected from a group of digitally modelled orthodontic element holders, a guide being selected from a group of digitally modelled guides suitable to cooperate with the selected orthodontic element holder, the selected guide being fit in the digitally modelled positioning template in function of the selected digitally modelled orthodontic element holder and the position of the at least one digitally modelled orthodontic element in the digital patients dentition model.

It is understood that first a digitally modelled guide may be selected, after which an appropriate orthodontic element holder may be selected from a group of digital models of orthodontic element holder, suitable to cooperate with the selected guide. Alternatively, first a digitally modelled orthodontic element holder may be selected, after which an appropriate guide may be selected from a group of digital models of guides, suitable to cooperate with the selected orthodontic element holder.

According to some embodiments of the present invention, the guide may be selected from a group of digitally modelled guides, the selected guide being fit in the digitally modelled positioning template in function of the position of the at least one digitally modelled orthodontic element in the digital dentition model. The method further may comprise the step of defining a digital model of an orthodontic element holder suitable to cooperate with the selected guide, and providing an orthodontic element holder based on the digital model of the orthodontic element holder.

The positioning template and the orthodontic element holder used and/or provided using this method may have one or more features as set out in relation to the device according to the first aspect of the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices, resulting in the provision of more efficient, stable and reliable devices of this nature.

The teachings of the present invention permit the design of improved methods for placing orthodontic elements to a dentition of a patient, which method allows more correct and reliable placing of the orthodontic element. By creating a positioning template optionally fit uniquely to at least a part of the dentition of the patient or at least a part of a model of the dentition, and, once the positioning template is placed on this part of the dentition or model, guiding the orthodontic element or elements via guides extending outwards from the positioning template (i.e. on the outer surface of the positioning template, in a direction away from the inner surface), the orthodontic element can be guided to a unique position and orientation for contacting, and optionally gluing, binding or coupling it, to the tooth of the dentition.

According to a method for placing an orthodontic element on a dentition of a patient, or a model of a dentition, first, a digital model of the dentition or the physical representation of the dentition is made. Thereafter, a planning of the orthodontic elements to be placed is done using computerised planning. A device, being a transfer device, maybe designed and created using a method according to the second aspect of the present invention. The device obtained, comprising a positioning template for use with an orthodontic element holder, or a device comprising a positioning template and an orthodontic element holder for cooperating with this positioning template, being a device according to the first aspect of the present invention, is positioned on the appropriate part of the dentition (or the model of the dentition). Then, the clinician applies or brings the orthodontic element in contact with the dentition (or the model of the dentition), guiding the orthodontic element holder by means of the guide present on the positioning template. As a result, the orthodontic element is positioned and oriented d correctly on the dentition or on the model of the dentition.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 is a schematic view of a device comprising a positioning template and a cooperating orthodontic element holder according to the present invention.

FIG. 2 is a detail of the positioning template being part of the device as shown in FIG. 1.

FIG. 3 is a detail of the orthodontic element holder being part of the device as shown in FIG. 1.

FIG. 4, shows alternative combinations of suitable orthodontic element holders and cooperating guides of devices according to embodiments of the present invention.

FIG. 5 represents a schematic view of an alternative device comprising a positioning template and a cooperating orthodontic element holder according to embodiments of the present invention.

FIG. 6 is a schematic view of an orthodontic element holder for cooperating with a device according to embodiments of the present invention.

FIG. 7 is a schematic representation of a computer system that can be used with the present invention.

FIGS. 8, 9 and 10 schematically show alternative orthodontic element holders for holding at least one orthodontic element, such as a bracket holder.

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “coupled”, also used in the claims, should not be interpreted as being restricted to direct connections only. The terms “coupled” and “connected”, along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

With regard to the embodiments of the present invention as represented in the figures, reference will be made to positioning of brackets on a dentition of a patient. It is understood however that brackets are only used as an example, which may be replaced by any suitable orthodontic element.

A goal of the present invention is to facilitate the transfer of the position and orientation of orthodontic brackets, as obtained by computer planning, to a patient's mouth.

A digital model of a patient's dentition is first obtained. To create the planning, a digital model of the patient's dentition can be obtained in any of several ways: via scanning of a negative (impression) of the teeth, via scanning of a model of the dentition, via direct intraoral scanning of the teeth, via a volumetric scan (CT, CBCT, . . . ), . . . . The brackets can then be positioned on the teeth via an automated program or via software tools which allows manual translation and rotation of brackets to position them on the teeth, or via a combination of both.

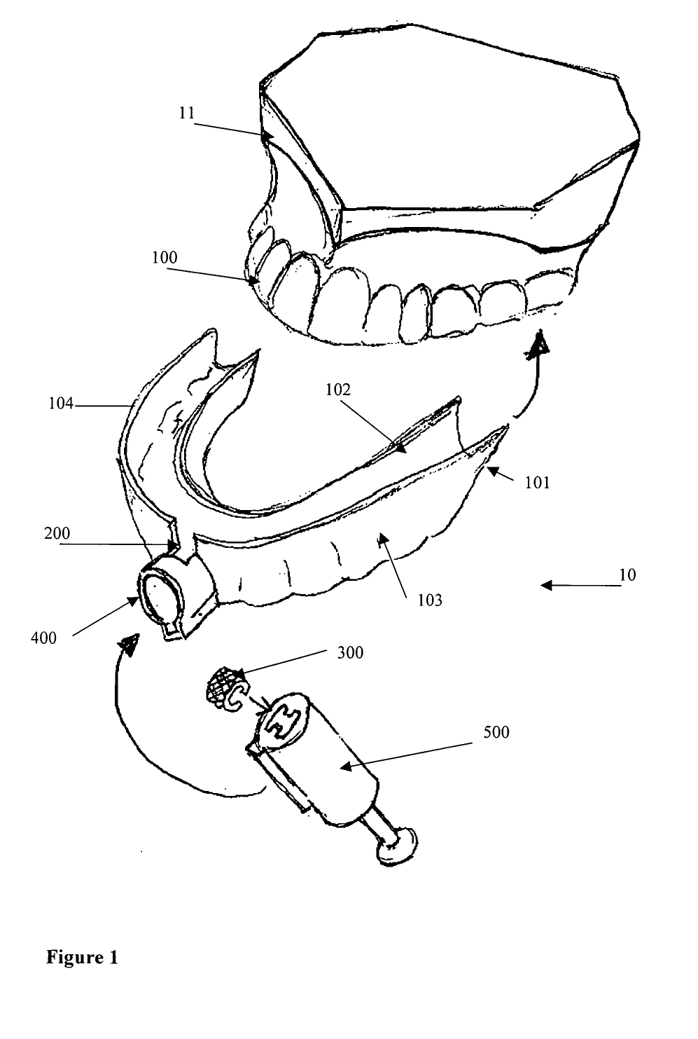

Based on this computer planning, a device 10 (FIG. 1) for positioning at least one orthodontic element on the dentition of a patient or on a physical model of a dentition, also called a “transfer device”, is created which consists of two parts: a positioning template 101 and a bracket holder 500, the combination of which provides a unique positioning of the brackets on the patient's teeth. The positioning template 101, as is shown in FIG. 1, is created based on the digital model of the patient's dentition 100, which can be obtained by one of the methods described above, in combination with the bracket positioning.

The positioning template 101 for fitting on at least a part of the dentition 100 of a patient has at least one, and in the embodiment illustrated only one, open area 200 for allowing an orthodontic element 300 to contact the dentition 100 of a patient. The positioning template 101 has an inner surface 102 for contacting the at least a part of the dentition of a patient, and an outer, opposite surface 103.

The positioning template 101 further is provided with at least one guide 400 coupled to the inner surface 102 via the outer surface 103 and the material constituting the positioning template. The guide 400 of the positioning template 101 is coupled to the outer surface 103 thereof and extends from the outer surface 103 in a direction opposite to or away from the inner surface 102. The inner surface 102 and outer surface 103 are opposite one to the other.

The guide 400 is suitable for cooperating with an orthodontic element holder 500 for guiding the orthodontic element 300, held by the orthodontic element holder 500 to the at least one open area 200.

The positioning template 101 is adapted to fit uniquely on the patient's teeth and can correspond to one or both arches, both fully or partially.

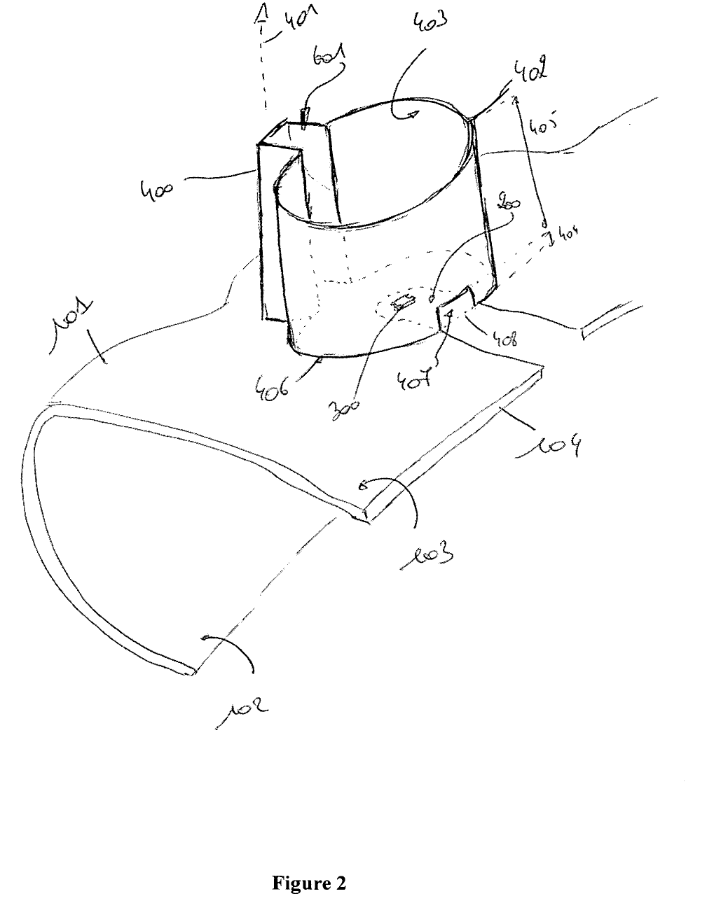

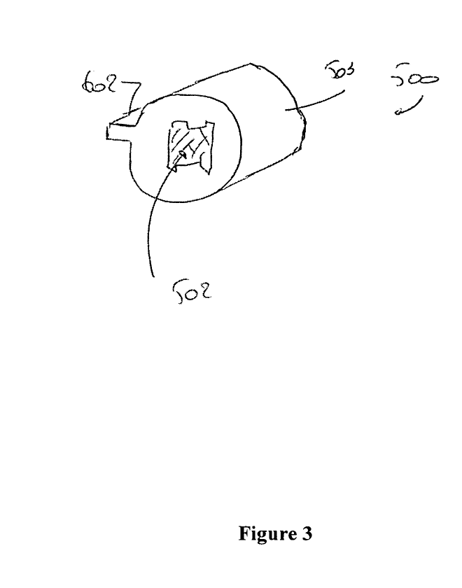

Turning now to a detailed view of the positioning template 101 as shown in FIG. 2, the positioning template 101 is provided with a guide 400 which, in the embodiment illustrated, is a tubular guide 400 having an axis 401, the axial direction of which extends from the outer surface 103 in a direction away from the inner surface 102. The guide 400 is adapted to guide a cooperating orthodontic element holder 500, e.g. bracket holder, to a correct position and orientation for releasing the orthodontic element 300, e.g. bracket. The tubular guide 400 defines a shaft 402 in axial direction, the shaft 402 being suitable for cooperating with the orthodontic element holder 500 as shown in FIG. 3.

The shaft 402 or ‘guiding shaft’ has a wall with an inner surface 403 being suitable for guiding, e.g. by contacting, the outer surface 503 of the orthodontic element holder 500.

At the level of the coupling 406 of the tubular guide 400 to the positioning template 101, the wall of the shaft 402 is open along at least a part 404 in the direction of the axis 401, i.e. an aperture 407 with a height indicated by 404 is provided in the wall. Along the remaining part 405 of the wall in the direction of the axis 401, the shaft 402 may have a closed wall, i.e. in embodiments of the present invention no further apertures are provided in the wall.

The aperture 407 allows for removal of the device 10 from the dentition 100 of a patient after positioning of the orthodontic element 300.

The positioning template 101 is provided with a soft tissue edge 104, which is the edge of the positioning template 101 to be oriented to the soft tissue 11 at the side of the dentition 100, tooth or teeth, to which the orthodontic element 300 is to be placed.

The aperture 407 has one side 408 delimited by the open area 200 of the positioning template 101.

The open area 200 of the positioning template 101 extends up to the soft tissue edge 104 of the positioning template 101. When removing the positioning template 101 after positioning and e.g. binding the orthodontic element(s) 300 to the tooth or teeth, the open area 200 extending up to the soft tissue edge 104 and the aperture 407 allow removing of the device 10 from the dentition 100 of the patient, by passing the orthodontic element 300 through the aperture 407. The dimensions of the aperture 407 are thus adapted to be sufficiently large to allow the orthodontic element 300 to pass through.

The open area 200 hence may have a part having a slit-like shape, which extends from the position where the orthodontic element 300 is to be placed up to the soft tissue edge 104 of the positioning template 101.

The device 10 further comprises an orthodontic element holder 500, which holder 500 is suitable to cooperate with the at least one guide 400.

The orthodontic element holder 500 and the guide 400 have a co-operating aligning means for aligning the orthodontic element holder 500 and the guide 400 in a unique relative position during guiding of the orthodontic element holder 500 by the guide 400.

As shown in FIG. 2 and FIG. 3, such aligning means may be a recession or a slot 601 in axial direction in the wall of the tubular guide 400, the orthodontic element holder 500 having a corresponding raised part 602 at its outer surface 503, for engaging, e.g. slidingly engaging, in this slot 601 in a unique position.

The orthodontic element holder 500 furthermore has a means 502 for holding an orthodontic element 300, e.g. a bracket, in place.

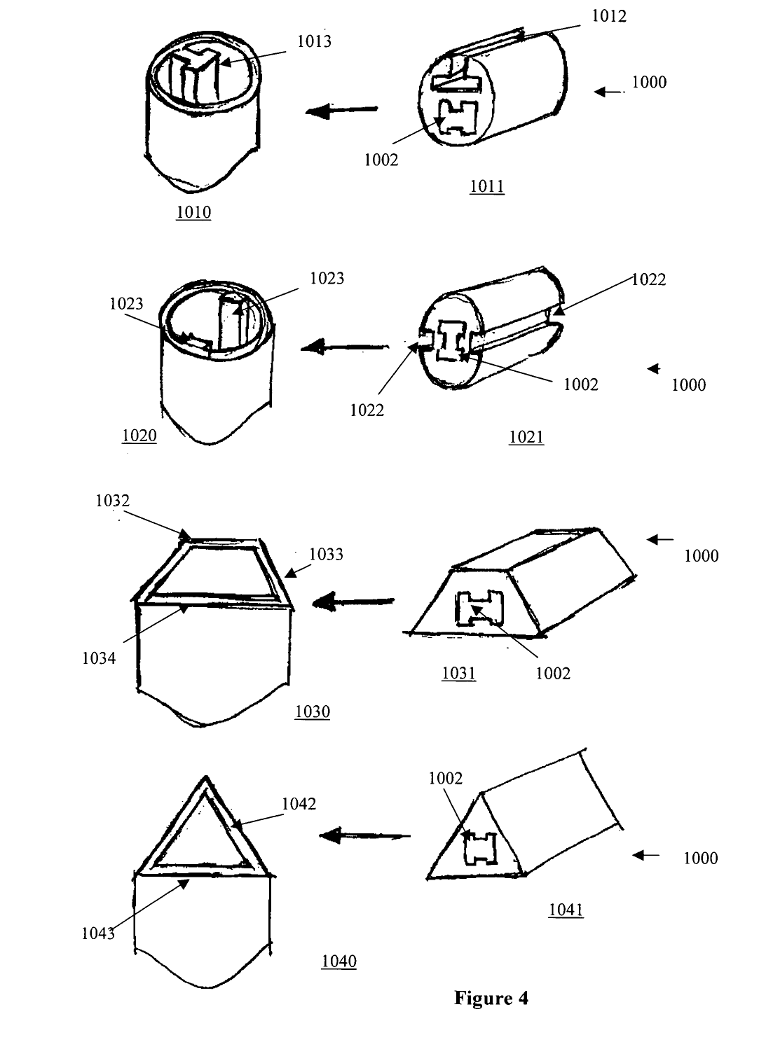

Alternatively the tubular guide 400 and the orthodontic element holder 500 may have an asymmetrical shape, so that the orthodontic element holder 500 can be positioned uniquely in the tubular guide 400 according to one relative position between the guide 400 and the orthodontic element holder 500. In such cases, a separate slot 601 in the tubular guide 400 and corresponding raised part 602 on the orthodontic element holder 500 are not necessary. Examples of such orthodontic element holders 500 with asymmetric shape are shown in FIG. 4.

In another embodiment of the invention, several tubular guides 400 are present in the positioning template 101. Adjacent tubular guides 400 may intersect, as long as unique guidance of the orthodontic element holder 500 in the tubular guide 400 is assured by the remaining portion of the tubular guide 400. The tubular guides 400 can have a (finite) rotational symmetry so that the user should position the orthodontic element holder 500 correctly in the tubular guide 400 (e.g. with the correct side facing upwards).

Alternative combinations of tubular guide and cooperating orthodontic element holder, in general indicated with reference 1000, are shown schematically in FIG. 4. The orthodontic element holder may fit in the guide and move, e.g. slide, against the inner surface of the guide in axial direction. The outer surface of the orthodontic element holder matches or engages with the inner surface of the tubular guide in only one position, or a limited number of positions, of the orthodontic element holder relative to the axis of the tubular guide. The limited number of positions may be obtained by means of aligning means or by the particular shape of tubular guide and orthodontic element holder.

The aligning means may be a recession or a slot 1012 in axial direction in the outer surface of the orthodontic element holder 1011, the guide 1010 having a raised part 1013 at its inner surface, for engaging, e.g. slidingly engaging, in this slot 1012 in a unique position. The recession 1012 and the corresponding raised part 1013 may have any suitable shape, for example in the embodiment illustrated they have corresponding T-shapes.

The aligning means may be two recessions or two slots 1022 in axial direction in the outer surface of the orthodontic element holder 1021, the guide 1020 having two corresponding raised parts 1023 at its inner surface, for engaging, e.g. slidingly engaging, in these slots 1012. As shown, the slots 1022 and raised parts 1023 may be radially oriented such that the orthodontic element holder 1021 may cooperate with the guide 1020 in two positions. In alternative embodiments (not illustrated), more than two recessions and corresponding slots may be provided. The one or more recessions may be provided in the guide, the corresponding raised parts then being provided on the orthodontic element holder, or the one or more recessions may be provided in the orthodontic element holder, the corresponding raised parts then being provided on the guide.

As a further alternative, the inner surface of the tubular guide 1030 may be substantially identical to the outer surface of the orthodontic element holder 1031. In one example illustrated, they both have a quadrangular shape having at least two sides, e.g. 1032, 1033 and 1034, having a different length, e.g. like a trapezoid shape. As another example, the inner surface of the tubular guide 1040 may be substantially identical to the outer surface of the orthodontic element holder 1041. The radial cross sections of the surfaces may be triangularly shaped. At least two sides of the triangular shape, e.g. side 1042 and 1043, may have a different length.

Each of the orthodontic element holders 1011, 1021, 1031 and 1041 is provided with a means 1002 for holding an orthodontic element, e.g. a bracket, in place

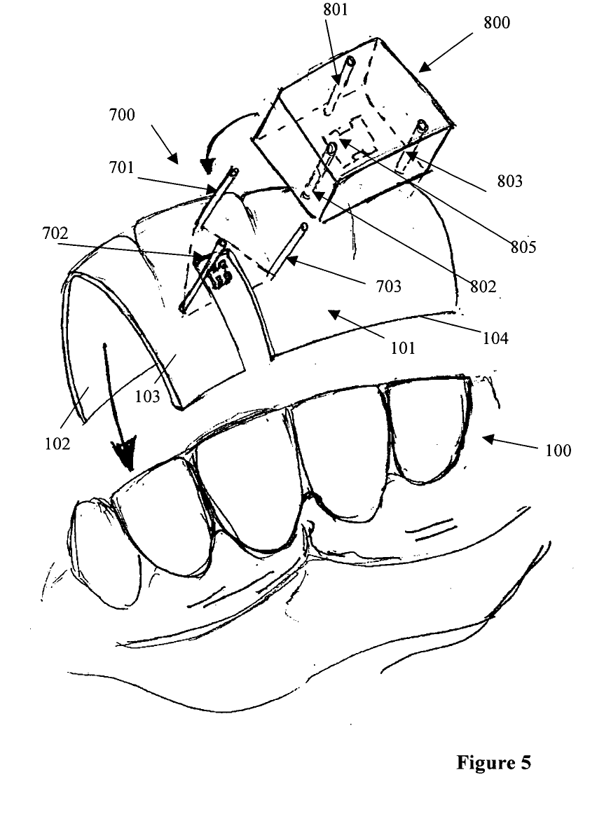

As a further alternative, shown in FIG. 5, the positioning template 101 has a guide 700, comprising a number of, e.g. three, studs 701, 702 and 703, such as cylindrical studs, extending from the outer surface 103 in a direction away from the inner surface 102. The polygonal area defined by the three studs 701, 702 and 703 may encompass the position on the dentition 100 where the orthodontic element is to be placed. The guide 700 is adapted to cooperate with a orthodontic element holder 800, in this embodiment being a solid part provided with a number of recessions equal to or outnumbering the number of studs, in the embodiment illustrated three recessions 801, 802 and 803. The recessions 801, 802, 803 are adapted to cooperate with the studs 701, 702 and 703. The shape of the studs 701, 702, 703 and recesses 801, 802, 803, and the mutual positioning of the studs 701, 702, 703 and recesses 801, 802, 803 may be such that the orthodontic element holder 800 may cooperate on only one relative position, or a limited number of relative positions, with the positioning template 101. The orthodontic element holder 800 further has a means 805 to hold an orthodontic element.

According to embodiments of the invention, the positioning templates 101 as set out above can be a part created by rapid prototyping which fits uniquely on part of one arch.

Turning to the second aspect of the present invention, a method for manufacturing a device for positioning at least one orthodontic element onto the dentition of a patient or onto a physical model of a dentition comprises the step of obtaining a digital model of a patients dentition. This may be obtained by any of a plurality of suitable ways: via scanning of a negative (impression) of the teeth, via scanning of a model of the dentition, via direct intraoral scanning of the teeth, via a volumetric scan (CT, CBCT, . . . ), . . . .

In a further step, digitally positioning at least one digitally modelled orthodontic element in the digital dentition model of the patient is done using appropriate software. The type of orthodontic element may be chosen from e.g. a library of known orthodontic elements, of which digital models are stored in a memory of a computer. Usually an orthodontist will define the most appropriate orientation and position of the chosen orthodontic element on the teeth.

A digitally modelled orthodontic element holder for holding at least one orthodontic element may be defined. This may be done by selecting an orthodontic element holder from a group of known orthodontic element holders. Alternatively, a suitable orthodontic element holder may be determined by creating a digital model of an appropriate orthodontic element holder, suitable to cooperate with the selected or defined orthodontic element, and suitable to bring the orthodontic element in the position and in the orientation as defined.

Based on the at least one digitally positioned orthodontic element, a digital model of a positioning template for fitting on at least a part of the dentition of a patient (or on a physical model of a dentition) is determined. The positioning template has at least one open area for allowing an orthodontic element to contact the dentition of a patient or a physical model of a dentition according to the digitally defined position. The positioning template has an inner surface for contacting the at least a part of the dentition of a patient or a physical model of a dentition, and an outer surface. The positioning template further comprises at least one guide coupled to the outer surface of the positioning template and extending from the outer surface in a direction opposite to, i.e. away from, the inner surface. The at least one guide is suitable for and adapted for cooperating with the orthodontic element holder for guiding the orthodontic element held by the orthodontic element holder throughout the at least one open area and onto the dentition.

Once the positioning template is determined and a digital model thereof is made, the positioning template 101 may be provided from the digital model by any suitable method, such as e.g. rapid prototyping or alike. The positioning template 101 and the one or more guides 400; 700 may be provided as an integral part, i.e. provided as one solid piece of material.

It is understood that, in order to obtain the guide 400; 700 and orthodontic element holder 500; 800 suitable for cooperation and suitable to bring the orthodontic element 300, e.g. a bracket, to a position and in an orientation as considered desirable by the orthodontist, the creation or definition of the guide 400; 700 and the corresponding orthodontic element holder 500; 800 maybe done in any of several alternative ways.

In one alternative embodiment, the at least one orthodontic element holder is selected from a group of digitally modelled orthodontic element holders. The at least one guide is defined and fits in the digitally modelled positioning template in function of the selected at least one digitally modelled orthodontic element holder and the position of the at least one digitally modelled orthodontic element in the digital dentition model of the patient.

In another alternative embodiment, the at least one orthodontic element holder is selected from a group of digitally modelled orthodontic element holders. Also the at least one guide is selected from a group of digitally modelled guides suitable to cooperate with the selected at least one orthodontic element holder. Once both are selected, the selected at least one guide is fit in the digitally modelled positioning template in function of the selected at least one digitally modelled orthodontic element holder and the position of the at least one digitally modelled orthodontic element in the digital dentition model of the patient.

In a further alternative, at least one guide is selected from a group of digitally modelled guides. The selected at least one guide is fit in the digitally modelled positioning template in function of the position of the at least one digitally modelled orthodontic element in the digital dentition model of the patient. Then, a digital model of at least one orthodontic element holder suitable to cooperate with the selected at least one guide is defined. Later, the at least one orthodontic element holder is provided based on the digital model of the orthodontic element holder.

The orthodontic element holder may thus be a customized part which encloses the orthodontic element uniquely, thus reflecting the position of the orthodontic element. It can also be created via rapid prototyping techniques. The side of the orthodontic element holder that comes into contact with a tooth surface preferably reflects the tooth's anatomy.

The use of a device according to embodiments of the first aspect of the present invention, which may be a device obtained by using the method according to embodiments of the second aspect of the present invention, includes positioning of the positioning template 101 on the dentition 100 of a patient. This is also true in case the positioning template 101 is made based on a digital representation of a model of the dentition 100 of a patient.

After positioning the positioning template 101 in the patient's mouth, and inserting an orthodontic element in an orthodontic element holder, e.g. a bracket in a bracket holder, the orthodontic element holder is brought into cooperation with the guide of the positioning template 101. This may e.g. be obtained by the insertion of the orthodontic element holder in the shaft of the tubular guide. Optionally, adhesive may be applied first to the base of the orthodontic element, e.g. to the bracket base, in order to connect the orthodontic element to the patient's dentition upon contact between the orthodontic element and the tooth. In case the guide comprises slots, the orthodontic element holder is positioned with its corresponding raised part in the slot. The orthodontic element is brought into contact with and fixed onto the tooth.

Optionally, in case of orthodontic elements, e.g. brackets, which are to be bond to the tooth using adhesive, after the adhesive has cured, the orthodontic element holder, e.g. bracket holder, can be removed and the positioning template can be removed from the patient's teeth.

It is to be understood that although preferred embodiments, specific constructions and configurations, as well as materials, have been discussed herein for devices according to the present invention, various changes or modifications in form and detail may be made without departing from the scope of this invention as defined by the appended claims. For example, the orthodontic element holder, e.g. bracket holder, can be a standard part which is the same for every patient but differs per orthodontic element, e.g. bracket, to have a unique positioning of the orthodontic element, e.g. bracket, in the holder. The unique location and orientation of the orthodontic element, e.g. bracket, on the tooth is thus transferred via the location and orientation of the guides.

Another embodiment of the invention involves a positioning template which fits on both arches simultaneously. The patient may be instructed to bite into the template to keep it in place.

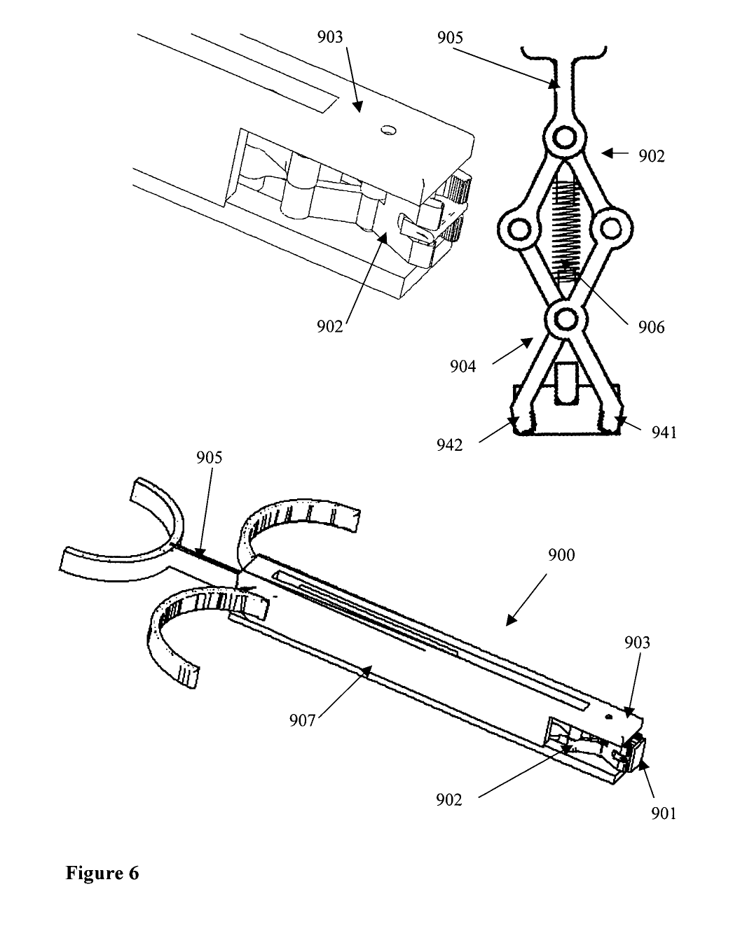

In yet another embodiment of the invention, as shown in FIG. 6, an orthodontic element holder 900, e.g. bracket holder, for holding at least one orthodontic element, is a tool which clamps the orthodontic element 901, e.g. bracket, like a special type of tweezers. The tool has a set of clamps 902 or similar clamping means for clamping the orthodontic element 901 in a unique way, so that the position of the orthodontic element 901 is known with respect to the outer surface 903 of the orthodontic element holder 900. The clamp 902 is a fastening device to hold or secure the orthodontic element 901 tightly to prevent movement through the application of inward pressure. The clamp 902 has, in this embodiment, two clamp tips or tweezers 941 and 942, between which the orthodontic element 901 is clamped. A shaft 905 is coupled to the clamp tips 941, 942 by means of a spring 906. By moving the shaft 905 towards the tweezers 941, 942 (as is done in this embodiment similarly as moving the plunger in a syringe), the tweezers 941, 942 will mutually move and open, thereby allowing the orthodontic element 901 to become disconnected from the tweezers 941, 942.

The guides 400, such as tubular guides defining shafts 402 in the positioning template 101, are positioned in such a way that the orthodontic element holder 900 is guided to the correct location and with the correct orientation for positioning and optionally bonding the orthodontic element 901. The tubular housing 907 of the orthodontic element holder 900 may have a rectangular cross-sectional shape, which matches with the shape of the guiding shaft 402 of the positioning template 101.

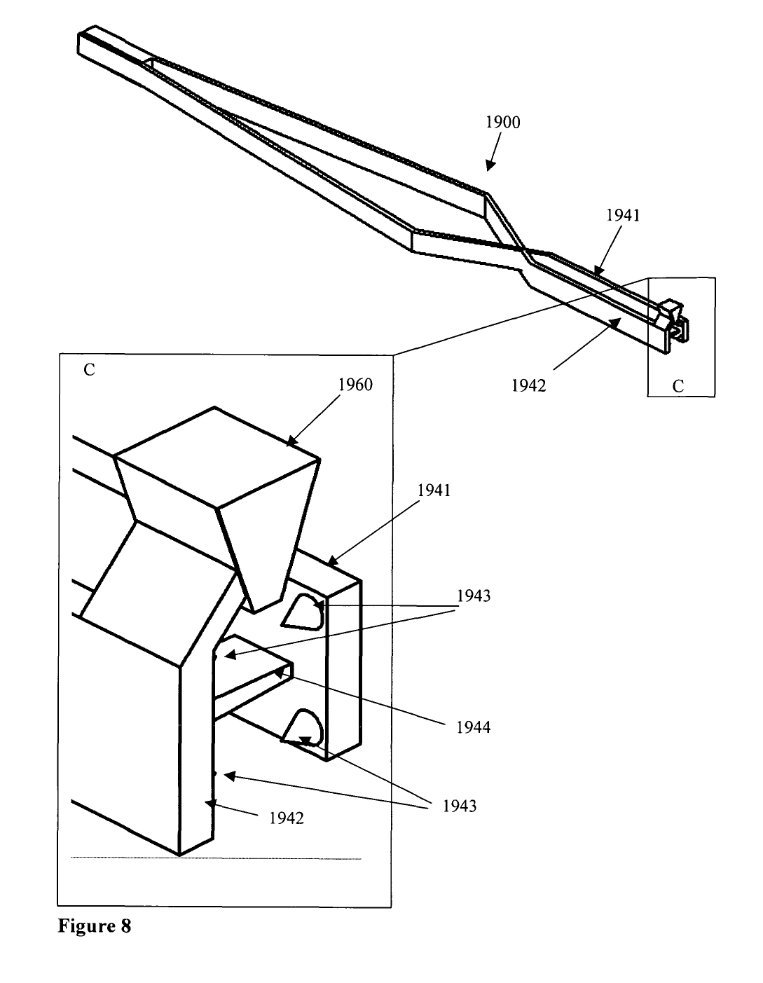

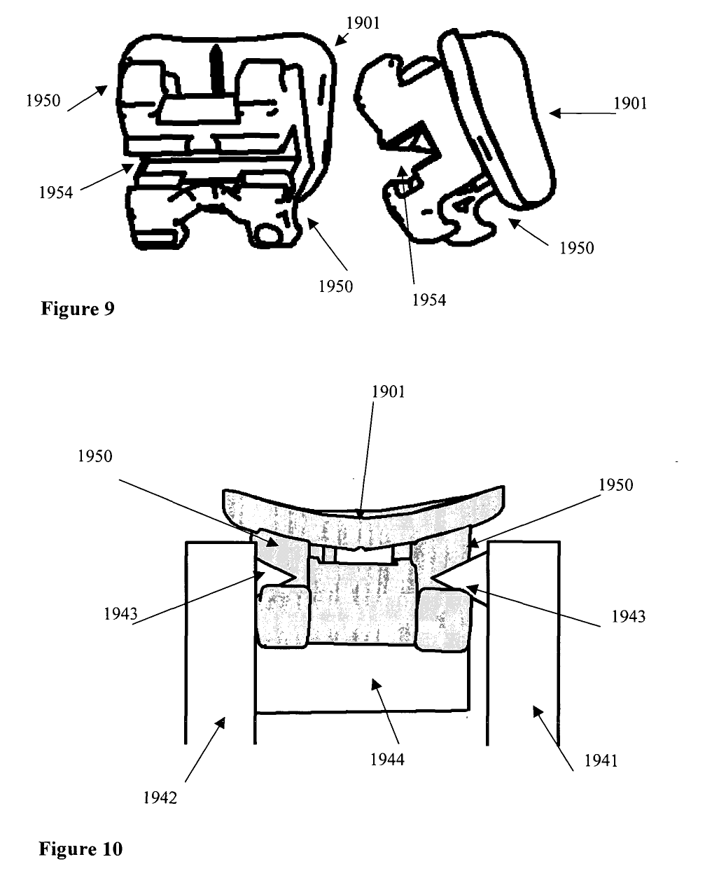

Alternative orthodontic element holders for holding at least one orthodontic element, such as the bracket holder 1900 are shown in FIGS. 8, 9 and 10. The orthodontic element, e.g. a bracket 1901 is held in position by cone-like protrusions 1943 at the tip of the two tweezers 1941 and 1942 that lock in place behind characteristic protrusions 1950 of the bracket 1901. In addition a lateral bar 1944, mounted on the tip of one or both of the tweezers 1941, 1942, in this embodiment on one of the tweezers 1942 engages in the slot 1954 of the bracket 1901.

An aligning means, e.g. a raised part 1960, in this particular embodiment illustrated a triangular part, mounted on the tip of one or both of the tweezers, in this embodiment on one of the tweezers 1942, may be provided. This raised part 1960 is adapted to slidingly engage in a cooperating recession in the guide of the positioning template 101.

In yet another embodiment of the invention the orthodontic element holder, e.g. a bracket holder, is a tool which contains extra guiding features, for instance wings which extend outward from the shaft of the tool. The guide, e.g. a shaft of the positioning template, does not engage the full tool, but only the guiding features. The construction of the guiding features and the positioning template may only allow the tool to enter the template up to a specified depth, allowing full 3D positioning control of the orthodontic element, such as a bracket.

It is understood that alternative embodiments of devices and methods may comprise more than one guide, the guides being identical, similar or different. One or more orthodontic element holders may be part of the device comprising more than one guide. The plurality of guides, or even all guides of the positioning template, may be suitable to cooperate with one orthodontic element holder, or each of the guides may be suitable to cooperate with a different, particular orthodontic element holder.

Methods in which more than one guide is positioned and fitted to the positioning template are understood by the skilled person as being part of the present invention.

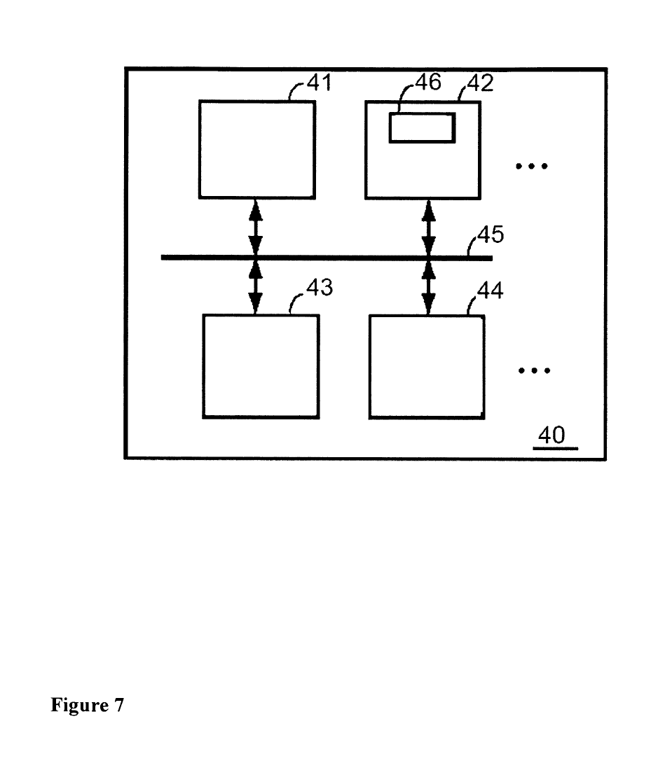

As indicated above the present invention also provides a processor system for use in dental planning. The processing system may include a computing device, e.g. microprocessor. Any of the methods described above according to embodiments of the present invention or claimed may be implemented in a processing system 40 such as shown in FIG. 7. FIG. 7 shows one configuration of processing system 40 that includes at least one customisable or programmable processor 41 coupled to a memory subsystem 42 that includes at least one form of memory, e.g., RAM, ROM, and so forth. It is to be noted that the processor 41 or processors may be a general purpose, or a special purpose processor, and may be for inclusion in a device, e.g. a chip that has other components that perform other functions. Thus, one or more aspects of the method according to embodiments of the present invention can be implemented in digital electronic circuitry, or in computer hardware, firmware, software, or in combinations of them. The processing system may include a storage subsystem 43 that has at least one disk drive and/or CD-ROM drive and/or DVD drive. In some implementations, a display system, a keyboard, and a pointing device may be included as part of a user interface subsystem 44 to provide for a user to manually input information, such as parameter values. Ports for inputting and outputting data, e.g. related to the planning also may be included. More elements such as network connections, interfaces to various devices, and so forth, may be included, but are not illustrated in FIG. 7. The various elements of the processing system 40 may be coupled in various ways, including via a bus subsystem 45 shown in FIG. 7 for simplicity as a single bus, but which will be understood to those in the art to include a system of at least one bus. The memory of the memory subsystem 42 may at some time hold part or all (in either case shown as 46) of a set of instructions that when executed on the processing system 40 implement the steps of the method embodiments described herein.

The present invention also includes a computer program product which provides the functionality of any of the methods according to the present invention when executed on a computing device. Such computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non-volatile media includes, for example, optical or magnetic disks, such as a storage device which is part of mass storage. Common forms of computer readable media include, a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fibre optics, including the wires that comprise a bus within a computer.

Other arrangements for accomplishing the objectives of the device embodying the invention will be obvious for those skilled in the art.

1. A device (10) for positioning at least one orthodontic element (300) on a dentition (100) by means of an orthodontic element holder (500) for holding the at least one orthodontic element (300), the device (10) comprising a positioning template (101) for fitting on at least a part of the dentition (100), the positioning template (101) having at least one open area (200) for allowing an orthodontic element (300) to contact the dentition (100), the positioning template (101) having an inner surface (102) for contacting the at least a part of the dentition (100) the positioning template (101) further being provided with at least one guide (400) coupled to and extending from the positioning template (101) in a direction away from the dentition (100) when the inner surface (102) is in contact with the dentition (100), the at least one guide (400) being suitable for cooperating with an orthodontic element holder (500) for guiding the orthodontic element (300) held by the orthodontic element holder (500) to the at least one open area (200).

2. A device according to claim 1, wherein the at least one guide (400) is a tubular guide having an axial direction (401), the axial direction (401) extending in a direction away from the inner surface (102), the tubular guide (400) defining a shaft (402) in axial direction (401), the shaft (402) being suitable for cooperating with the orthodontic element holder (500).

3. A device (10) according to claim 2, wherein the shaft (402) has a wall with an inner surface (403) being suitable for contacting an outer surface (503) of the orthodontic element holder (500).

4. A device (10) according to claim 3, wherein the wall of the shaft (403) is provided with an aperture (407) for allowing passage of an orthodontic element (300).

5. A device (10) according to claim 4, wherein the wall of the shaft (402) is provided with the aperture (407) at the coupling of the tubular guide (400) to the positioning template (101).

6. A device (10) according to any one of the claims 2 to 5, wherein the tubular guide (400) has an aperture (407) for allowing removal of the device (10) from the dentition (100) after positioning the orthodontic element (300).

7. A device (10) according to any one of the preceding claims, wherein the device (10) further comprises an orthodontic element holder (500), suitable to cooperate with the at least one guide (400).

8. A device (10) according to claim 7, wherein the orthodontic element holder (500) and the guide (400) have an aligning means for aligning the orthodontic element holder (500) and the guide (400) in a unique relative position during guiding of the orthodontic element holder (500) by the guide (400).

9. A device (10) according to any one of the preceding claims, wherein the open area (200) of the positioning template (101) extends up to a soft tissue edge (104) of the positioning template (101) for allowing removal of the device (10) from the dentition (100) after positioning of the orthodontic element (300).

10. A method for manufacturing a device (10) for positioning at least one orthodontic element (300) on a dentition (100), the method comprising the steps of:
Obtaining a digital model of a dentition;
Digitally positioning at least one digitally modelled orthodontic element in the digital dentition model;
Determining a digitally modelled orthodontic element holder for holding at least one orthodontic element;
Determining, based on said at least one digitally positioned orthodontic element, a digital model of a positioning template (101) for fitting on at least a part of the dentition (100), the positioning template (101) having at least one open area (200) for allowing an orthodontic element (300) to contact the dentition (100) according to the digitally defined position, the positioning template (101) having an inner surface (102) for contacting the at least a part of the dentition (100), the positioning template (101) further being provided with at least one guide (400) coupled to and extending from the positioning template (101) in a direction away from the dentition (100) when the inner surface (102) is in contact with the dentition (100), the at least one guide (400) being suitable for cooperating with an orthodontic element holder (500) for guiding the orthodontic element (300) held by the orthodontic element holder (500) to the at least one open area (200);
providing the positioning template (101) of the device (10) for positioning the at least one orthodontic element (300) on the dentition (100).

11. A method according to claim 10, wherein an orthodontic element holder (500) is selected from a group of digitally modeled orthodontic element holders, the guide (400) is defined and fit in the digitally modeled positioning template in function of the selected digitally modeled orthodontic element holder and the position of the at least one digitally modeled orthodontic element in the digital dentition model.

12. A method according to claim 10, wherein an orthodontic element holder (500) is selected from a group of digitally modeled orthodontic element holders, a guide (400) is selected from a group of digitally modeled guides suitable to cooperate with the selected orthodontic element holder, the selected guide is fit in the digitally modeled positioning template in function of the selected digitally modeled orthodontic element holder and the position of the at least one digitally modeled orthodontic element in the digital dentition model.

13. A method according to claim 10, wherein the guide (400) is selected from a group of digitally modeled guides, the selected guide is fit in the digitally modeled positioning template in function of the position of the at least one digitally modeled orthodontic element in the digital dentition model, the method further comprising the step of defining a digital model of an orthodontic element holder (500) suitable to cooperate with the selected guide, and providing an orthodontic element holder based on the digital model of the orthodontic element holder.

14. A device (10) for positioning at least one orthodontic element (300) on a dentition (100) obtained by the manufacturing process of any of claims 10 to 13.
